(19) United States
(12) Patent Application Publication
(10) Pub. No.: US 2002/0195972 A1
(43) Pub. Date: Dec. 26, 2002

(54) Lamp operating device having a starter circuit

(76) Inventor: Minoru Komori, Yokohama-shi (JP)

Correspondence Address: NIXON PEABODY, LLP, 8180 GREENSBORO DRIVE, SUITE 800, MCLEAN, VA, 22102, US

(21) Appl. No.: 10/160,103

(22) Filed: Jun. 4, 2002

(30) Foreign Application Priority Data
Jun. 6, 2001 (JP) 2001-170859

(51) Int. Cl. H05B 41/16

(52) U.S. Cl. 315/276

(57) ABSTRACT

A starter circuit having a pulse transformer reduced in size so as to reduce the heating power, to make the starter circuit smaller and to make a lamp operating device smaller. The pulse transformer has a plurality of windings connected in parallel to one another on the primary side of the pulse transformer. In a first embodiment, the respective plurality of windings connected parallel to one another are located next to one another on a core of the pulse transformer, and are wound around the core such that the coupling of the primary windings to the secondary winding is increased. Hence, the number of turns per unit length of the secondary winding is reduced. Accordingly, the length of the pulse transformer in the axial direction is also reduced, and the pulse transformer is made smaller. Further, in a second embodiment, the respective plurality of windings on the primary side connected parallel to one another are located next to one another on the core of the transformer and are wound around the core such that after completion of a winding, a next winding starts.

### BACKGROUND OF THE INVENTION

1. Field of the Invention

The invention relates to a lamp operating device having a starter circuit. The invention relates especially to a lamp operating device in which a pulse transformer of the starter circuit of the lamp operating device is reduced in size so that the starter circuit and the lamp operating device are made smaller.

2. Description of Related Art

In the operation of a discharge lamp of the short arc type, such as a super-high pressure mercury lamp, a xenon lamp or the like, a high voltage is supplied to the electrodes with a frequency of greater than or equal to 1 MHz, whereby an insulation breakdown is produced and luminous operation is effected.

The means for supplying the above described high voltage is a circuit called a “starter circuit”. This starter circuit is also called an “igniter” or “starter”. The starter circuit comprises a pulse transformer by which the high voltage is produced. Such a transformer is also called a “Tesla coil”. Conventionally, there is a starter circuit in the operating device of the above-described discharge lamp.

FIG. 6 schematically shows the arrangement of a lamp operating device of prior art that operates a discharge lamp of the short arc type. The lamp operating device is divided into ballast 11 and a starter circuit part 12, as shown in FIG. 6. The ballast 11 converts the alternating current from an AC line current source into a direct current and controls the wattage that is supplied to the discharge lamp (hereinafter as a lamp) 13. The ballast 11 comprises, for example, as shown in FIG. 6, a primary side rectifier smoothing circuit 11a which commutates and smoothes the alternating current from the line current source, an inverter circuit 11c which converts the direct current output by the primary side rectifier smoothing circuit 11a into an alternating current with a high frequency, a transformer 11d, a secondary side rectifier smoothing circuit 11e which commutates and smoothes the output of the transformer 11d, and a control element 11b which controls the above described inverter circuit 11c. Based on the current that flows through the lamp 13, the control element 11b controls the inverter circuit 11c and the wattage supplied to the lamp 13. The starter circuit 12 has a pulse transformer 12a which generates a high voltage producing an insulation breakdown between the electrodes of the lamp when operation of the discharge lamp starts.

FIG. 7 shows one example of an arrangement of the above-described starter circuit 12. The starter circuit 12 comprises, as shown in FIG. 7, a series connection of a diode D1 connected to a line current source and a capacitor C1, a semiconductor switch SW1, a set-up transformer Tr1 having a primary side with one terminal connected to the semiconductor switch SW1 and with the other terminal connected to the capacitor C1, a series connection of the diode D2 connected to a secondary side of the set-up transformer Tr1 and the capacitor C2, a semiconductor switch SW2 which is closed when a given voltage is applied, and a pulse transformer 12a.

In FIG. 7, the alternating current is supplied from the line current source via the diode D1 to charge the capacitor C1. When the voltage of the capacitor C1 increases up to a given voltage, the semiconductor switch SW1 is closed. The electrical charge stored in the capacitor C1 is then discharged. Thus, a voltage is applied to the primary side of the setup transformer Tr1. Via electromagnetic induction coupling (hereafter as coupling), a voltage is formed on the secondary side of the set-up transformer Tr1, and the voltage on the secondary side is applied via the diode D2 to the capacitor C2 so as to charge the capacitor C2.

By repeating the above described process, the charged voltage of the capacitor C2 is increased. When this voltage reaches, for example, 8 kV, the semiconductor switch SW2 is closed. In this way, a pulse-like current is applied to the primary side of the pulse transformer 12a. On the secondary side of the pulse transformer 12a a pulse-like voltage of, for example, 30 kV is formed via electromagnetic induction coupling, i.e., coupling. The period of the pulse-like voltage which is formed on the secondary side of the above described pulse transformer 12a is normally five to six times per second.

In a discharge lamp with nominal values of, for example, 250 W (40 V, 6 A), it is necessary for the voltage between the electrodes of the discharge lamp to reach at least 20 kV, desirably of greater than or equal to 23 kV to 24 kV, to achieve an insulation breakdown.

For supplying the high voltage to the lamp 13, a pulse transformer 12a of the starter circuit part 12 is used with a primary side which has been wound roughly by three turns and with a secondary side which is been wound by roughly 20 to 30 turns. As described above, a pulse-like voltage of a high frequency with roughly 8 kV and a few MHz is applied to the primary side. A pulse-like voltage of a high frequency with roughly 20 kV to 30 kV and a few MHz is output from the secondary side of the pulse transformer.

FIGS. 8(a) and 8(b) show one example of a conventional pulse transformer. As shown in FIG. 8(a), a secondary winding 2 is wound onto a core 1. For safety reasons, an insulating plate 3 is inserted thereon. A primary winding 4 is then wound onto the insulating plate 3. FIG. 8(b) is an illustration of the pulse transformer viewed from the axial direction of the core 1. As shown in FIG. 8(b), the core 1 is wound with the windings 2 and 4.

The primary winding 4 is formed, for example, by roughly three turns and the secondary winding 2 is formed by for example roughly 20 turns to 30 turns. A length L of the pulse transformer depends on the winding length of the secondary winding 2. As shown in FIG. 8(a), the length of the pulse transformer is represented by the winding length L of the secondary winding. The winding length L is essentially identical to the length of the core 1.

Recently, devices have been produced more frequently with lamps that require a greater wattage than conventional lamps. For example, in an exposure device that exposes display substrates, such as liquid crystals or the like which increasingly larger every year, it is desirable to be able to expose large areas with high irradiance. In one such exposure device, a lamp with a greater wattage than a conventional lamp, i.e. a wattage from 3.5 kW to 8 kW, is more frequently used. The nominal power rating values of these lamps are, for example, 5 kW (25 V, 200 A), 8 kW (70 V, 110 A), and 10 kW (100 V, 100 A).

The voltage of a discharge lamp depends on the distance between the electrodes and the gas pressure within the bulb. In discharge lamps that are used for exposure devices and the like, the optical efficiency is maintained even if the wattage is increased. The distance between the electrodes and the gas pressure within the bulb do not change to a major extent. When the nominal wattage is increased, the current is increased accordingly.

As described above, the distance between the electrodes hardly changes, even if the lamp wattage is increased. The insulation breakdown voltage also does not change and conventionally is at least 20 kV, desirably greater than or equal to 23 kV to 24 kV. The ratio of the number of winding of the pulse transformer of the starter circuit for the higher wattage lamp is therefore identical to the conventional one.

The current flowing in the higher wattage lamp is, for example, at least roughly 15 times greater compared to a lamp with 250 W (6 A). Therefore, according to the current carrying capacity, the cross sectional area of the winding on the secondary side of the pulse transformer through which the lamp current flows must be increased, i.e. the thickness of the winding must be increased.

When the thickness of the winding is increased, at the same number of turns per unit length the pulse transformer's size is also enlarged. When the lamp current increases, the thickness of the winding on the secondary side with the larger number of turns per unit length must be increased according to the current carrying capacity. In this way, the winding length L of the secondary side of the pulse transformer becomes accordingly larger.

The winding length of the secondary winding of the pulse transformer for a lamp with 250 W (6 A) is, for example, roughly 8 cm. In a pulse transformer for a lamp with 5 kW (200 A), a copper wire having a rectangular cross-section of, for example, 6 mm×8 mm is used. The length L is therefore roughly 20 cm (in the case of 26 turns on the secondary side).

Since the secondary winding has a large number of turns per unit length and a long length, initially the power loss produces a large amount of heat. When the current flowing in the winding becomes large, the power loss through heat-generation becomes even greater. Therefore, in the starter circuit of the lamp with a high wattage, there is a cooling fin for the pulse transformer, and the pulse transformer is subjected to compressed air cooling.

As previously mentioned, when the lamp current increases, the pulse transformer's size is enlarged. Consequently, the entire starter circuit is enlarged. Furthermore, since the heating power is great, a large cooling fin must be installed. The size of the entire starter circuit is roughly 250 mm×350 mm×150 mm. Therefore, increasing the size of the starter circuit also increases the size of the entire lamp operating device.

The shorter the distance between the starter circuit and the discharge lamp, i.e., shorter the installation line, the better it is to prevent a voltage reduction. Therefore, the starter circuit is normally located within the light irradiation device which houses a lamp and a focusing mirror, or the starter circuit is located outside the light irradiation device. When the starter circuit becomes larger, there is insufficient space for its arrangement within the light irradiation device. Even if the starter circuit part is installed outside the light irradiation device, the light irradiation device becomes larger.

On the other hand, the size of the pulse transformer can be reduced if the coupling of the primary side and the secondary side of the pulse transformer can be increased, and the number of turns per unit length of the windings can be reduced. As a method for increasing the coupling of the transformer, there is generally a known process called “sandwich winding”. In this process, a primary winding is wound onto the core of the transformer, and a secondary winding is wound on the primary winding. In other words, in this process, the primary winding and the secondary winding are wound alternately. This “sandwich winding” is, however, considered to be a disadvantage in that it is difficult to route the windings around and to install an insulation plate. Therefore, its production is difficult. Furthermore, there are cases in which the capacitance coupling of the primary windings and the secondary winding becomes large. When the capacitance coupling becomes large, and when the pulse-like voltage has a frequency of greater than or equal to 1 MHz, the output voltage on the secondary side is reduced.

### SUMMARY OF THE INVENTION

It is therefore an object of the present invention is to eliminate the above described disadvantages in the prior art. More particularly, an object of the invention is to reduce the size of the pulse transformer in the starter circuit for a lamp with high wattage. Furthermore, it is also an object to reduce the power loss through heat, to make the starter circuit part smaller, and to make the lamp operating device smaller.

According to an embodiment of the invention, the coupling of the primary side and the secondary side of the pulse transformer is increased, and the size of the pulse transformer, of the starter circuit part, and of the lamp operating device are reduced by a process which differs from the above-described “sandwich winding” process.

In a pulse transformer of the present invention, there are a secondary winding and a primary winding, as shown in FIG. 1(b). Further, there are a plurality of windings of the primary side of the pulse transformer connected parallel to one another. For example, as shown in FIG. 1(a), the primary windings are wound onto the secondary winding so that coupling of the primary side to the secondary side is increased, and the number of turns per unit length of the secondary winding was reduced. As shown in FIG. 1(a), the secondary winding is formed by a layer of wire wound onto a core, in which a current of greater than or equal to 100 A can flow. The primary winding shown therein has a smaller winding number than the secondary winding.

A circuit which is formed as follows can be used as the starter circuit, such as that of the above-described circuit:

On the secondary side of a set-up transformer there is a capacitor C2 which is charged via a diode, as shown in FIG. 1(b);

parallel to the capacitor C2, a series circuit is connected, which includes the primary winding of the pulse transformer and a semiconductor switch SW2;

the semiconductor switch SW2 is closed when the voltage on the two ends of this capacitor reaches a given voltage; and

by discharging the capacitor C2 the voltage is applied to the primary side of the pulse transformer 12a.

The number of turns per unit length of the secondary winding with a larger diameter is reduced by the above described arrangement of the pulse transformer. Therefore, the winding length L of the secondary winding of the pulse transformer and the length of the pulse transformer in the axial direction can be reduced. In this manner, the pulse transformer 12a can be made smaller.

Furthermore, the length of the secondary winding through which a high current flows also becomes smaller, and the electrical resistance also becomes smaller. Consequently, the power loss due to heat also is reduced, the cooling fin of the pulse transformer is made smaller or is no longer needed. Accordingly, the starter circuit can be made smaller, and, as a result, the lamp operating device can be made smaller.

By winding a plurality of windings of the primary side in parallel to one another, in the manner described below, the coupling of the primary side to the secondary side can be increased, and the number of turns per unit length of the secondary winding can be reduced. The primary windings may be configured in two configurations as follows:

(1) The respective plurality of windings are connected parallel to one another. After completion of a winding process of one winding the winding process of the next winding is started, wherein the windings are located on the core of the pulse transformer and are wound around the core.

(2) The respective windings connected parallel to one another are located next to one another on the core of the pulse transformer and are wound around the core.

By winding in the manner described above in (1), the peak voltage which is output by the starter circuit can be increased more than in the winding in the manner described above in (2). In these ways, insulation breakdown of the lamp can be achieved even if the voltage is slightly reduced.

The invention is further described below using several embodiments shown in the drawings.

### BRIEF DESCRIPTION OF THE DRAWINGS

FIG. 1(a) shows a schematic of the arrangement of a first embodiment of the pulse transformer;

FIG. 1(b) shows a schematic of the primary winding and of the circuitry of a starter circuit according to the first embodiment of the invention;

FIG. 2 shows a schematic of the output waveform of the starter circuit when using the pulse transformer as shown in FIG. 1;

FIG. 3 shows a plot of the output waveform of a starter circuit when using a conventional pulse transformer;

FIG. 4 shows the arrangement of a second embodiment of the pulse transformer of the invention;

FIG. 5 is a plot of the output waveform of a starter circuit when using the pulse transformer as shown in FIG. 4;

FIG. 6 shows a schematic of a known arrangement of a lamp operating device which operates a discharge lamp of the short arc type;

FIG. 7 shows a schematic of one example of a known arrangement of a starter circuit; and

FIGS. 8(a) and 8(b) each shows a schematic of an exemplary arrangement of a conventional pulse transformer.

### DETAILED DESCRIPTION OF THE INVENTION

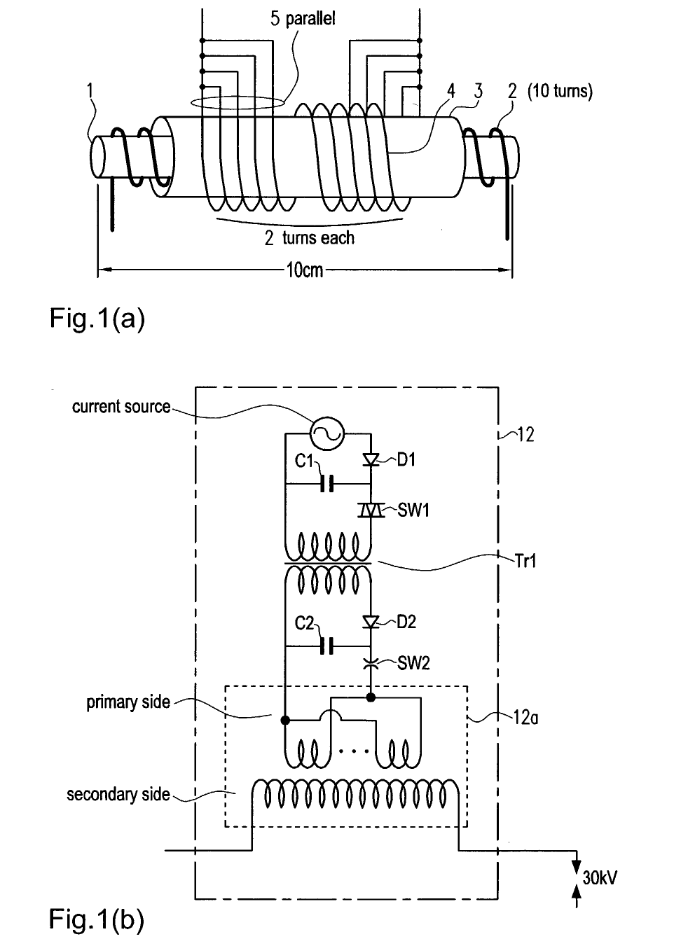

FIG. 1(a) shows the arrangement of a first embodiment of the pulse transformer in accordance with the invention. FIG. 1(b) shows the circuitry of the primary winding and of the starter circuit in this first embodiment. In the embodiment described below, a pulse transformer used in an operating device for a lamp with nominal power rating values of 5 kW (200 A) is described. It is noted that the same embodiment can also be applied to a pulse transformer used in operating devices for the lamps with power ratings of 8 kW(70 V, 10 A) and 10 kW(100 V, 100 A).

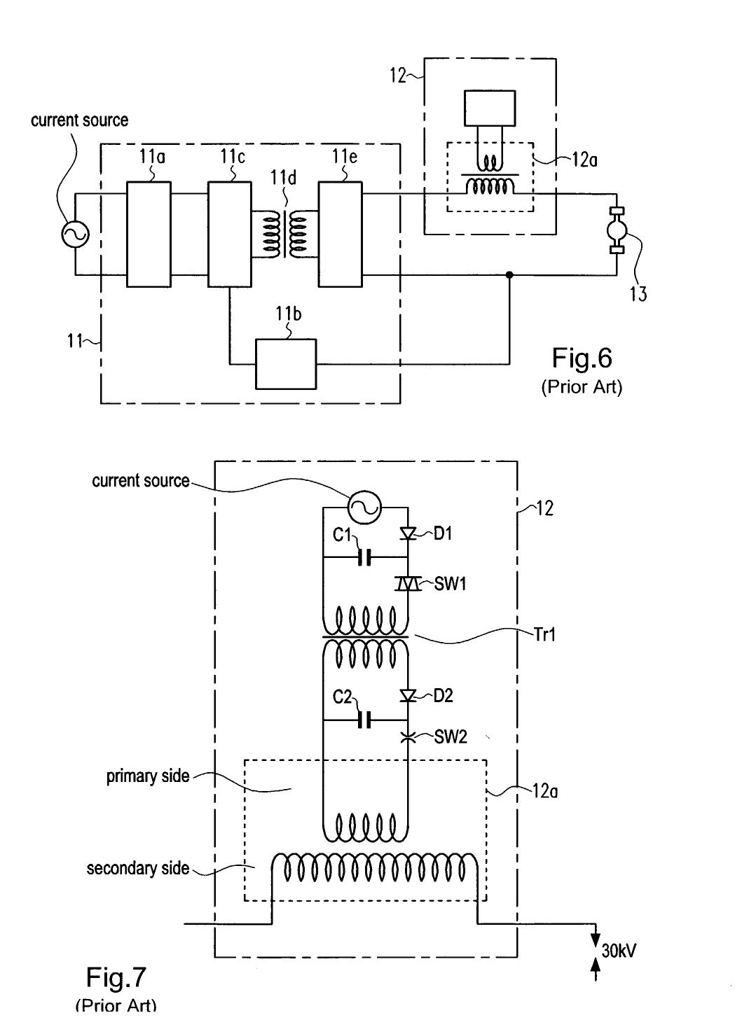

As shown in FIG. 1(b), the pulse transformer 12a of the present invention is used in a starter circuit with the same circuitry as the prior art circuitry shown in FIG. 7. The operation of the starter circuit is identical to the operation described above using FIG. 7. The starter circuit shown in FIG. 1(b) is used for the lamp operating device described above using FIG. 6.

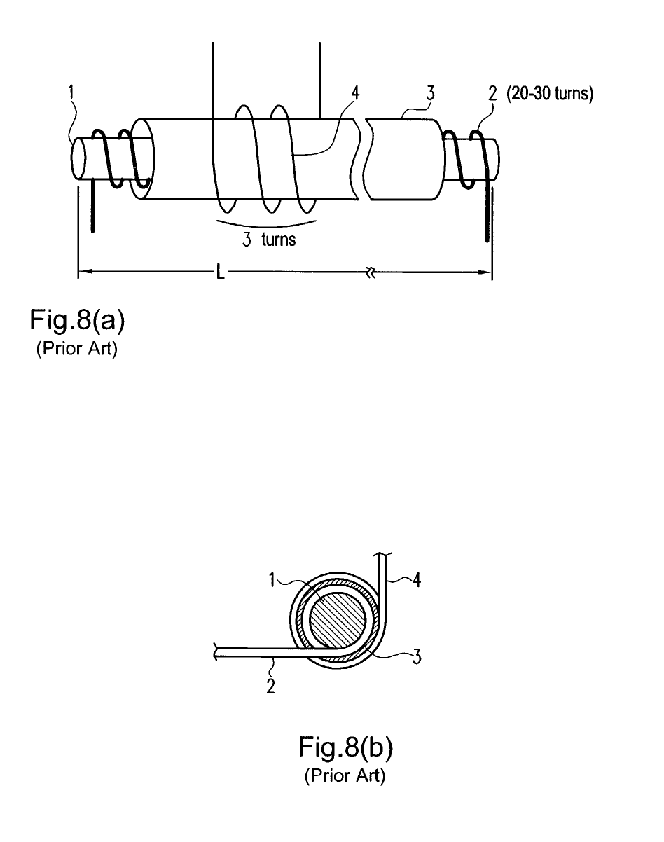

In the pulse transformer 12a in this embodiment of the invention, as in the prior art pulse transformer shown above using FIG. 8(a) and FIG. 8(b), a secondary winding 2 is wound onto the core 1. The insulating plate 3 is placed on the secondary winding, and the primary winding 4 is wound onto the insulating plate 3. In this embodiment, as shown in FIG. 1(a), there are five primary windings 4 located parallel to one another. The respective windings connected parallel to one another are located on the core of the pulse transformer 12a and are wound around the core. Further, as shown in FIG. 1(a), five windings 4 of the primary side are connected parallel to one another and are located next to one another. The five windings 4 are distributed uniformly on the core and are wound by two turns. The secondary winding 2 has ten turns. The winding length L of the secondary winding of the pulse transformer 12a in this case is roughly 10 cm.

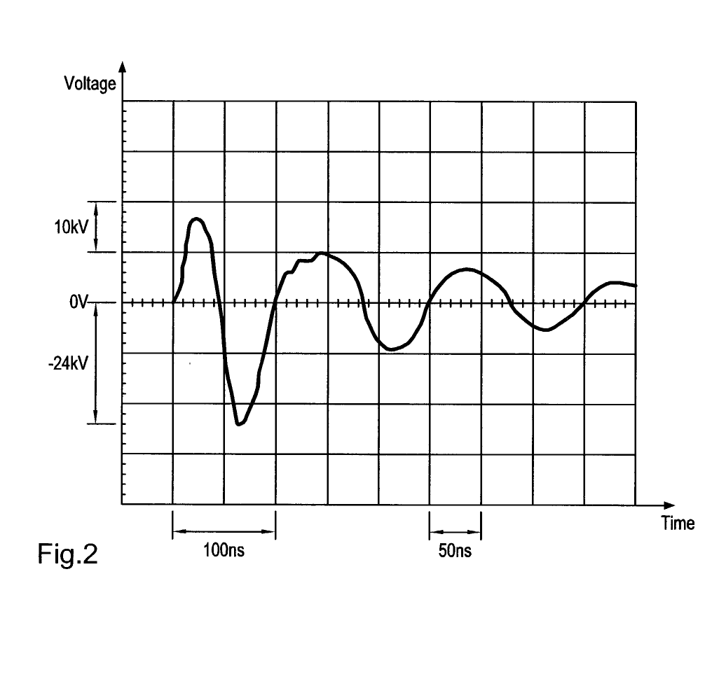

FIG. 2 shows the output waveform from the starter circuit in an application of the pulse transformer 12a shown in FIG. 1(a) and FIG. 1(b). In FIG. 2, using the starter circuit shown in FIG. 7 with the pulse transformer 12a in FIG. 1(a), the voltage waveform of the secondary side of the pulse transformer 12a is measured. Here, the x-axis plots the time, and a scale of 50 ns is shown. The y-axis plots the voltage, and a scale of 10 kV is shown.

As shown in FIG. 2, a voltage with a peak voltage of −24 kV and a period of roughly 100 ns (10 MHz) is output from the starter circuit 12 in which the pulse transformer 12a shown in FIG. 1(a) and FIG. 1(b) is used. Here, an insulation breakdown of a discharge lamp is obtained with efficiency.

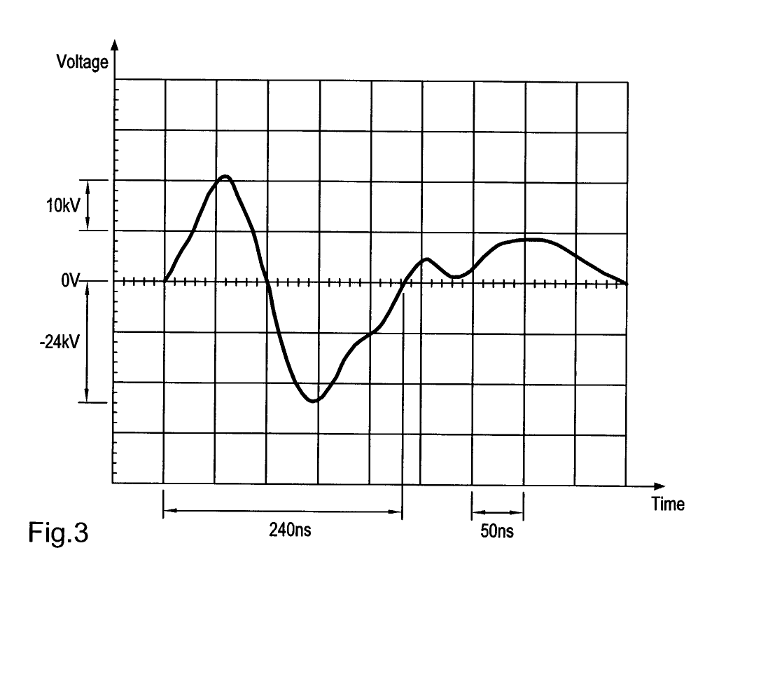

In contrast, FIG. 3 shows the output waveform from a starter circuit using the conventional pulse transformer shown in FIG. 8(a) and FIG. 8(b). FIG. 3 shows a case of the use of a pulse transformer for a lamp with a secondary winding wound by 26 turns, with a length L of roughly 20 cm and with 5 kW (200 A). As in FIG. 2, the starter circuit shown above using FIG. 7 was used and the voltage waveform on the secondary side of the pulse transformer 12 was measured. Here, the x-axis plots the time with a scale of 50 ns and the y-axis plots the voltage with a scale of 10 kV. As shown in FIG. 3, a voltage with a peak voltage of −24 kV and a period of roughly 240 ns (4.2 MHz frequency) was output from the starter circuit using the pulse transformer shown in FIG. 8(a) and FIG. 8(b).

In this embodiment described above, the same peak voltage as in the starter circuit using a conventional pulse transformer is obtained, even if the winding number of the secondary winding of 26 turns of a conventional pulse transformer is reduced to 10 turns. It can be understood that the reason for this is that the parallel arrangement of the primary windings of the present invention increases the coupling of the primary side to the secondary side of the pulse transformer, and thus, the required voltage output is obtained, even though the winding number of the secondary side has been reduced. Therefore, the winding length L of the secondary winding 2 of the pulse transformer 12a is reduced accordingly, and roughly half of the conventional winding length, i.e., a winding length L of roughly 10 cm, is obtained. The period of the voltage in FIG. 2 is roughly 100 ns which is shorter than in the conventional case as shown in FIG. 3. However, there is no disadvantage with respect to lamp operation.

With respect to the size of the pulse transformer for a high current, the number of turns per unit length of the secondary winding with a greater diameter for securing the current power is critical. In this embodiment, the number of turns and the number of turns per unit length of the primary winding 4 are increased. However, since the current of the primary side is a conventional value, for example, roughly 0.1 mA, i.e. is small, the diameter of the winding is small. The pulse transformer 12a, therefore, does not become large even if the number of turns and the number of turns per unit length of the winding increase slightly.

Furthermore, the number of turns per unit length of the secondary winding 2 becomes less and the length L becomes smaller. The power loss due to heat generation also decreases in proportion thereto. Therefore, only a very small amount of air is needed for air-cooling the pulse transformer 12a of the present invention. A cooling fin smaller than a conventional cooling fin is also sufficient for the pulse transformer.

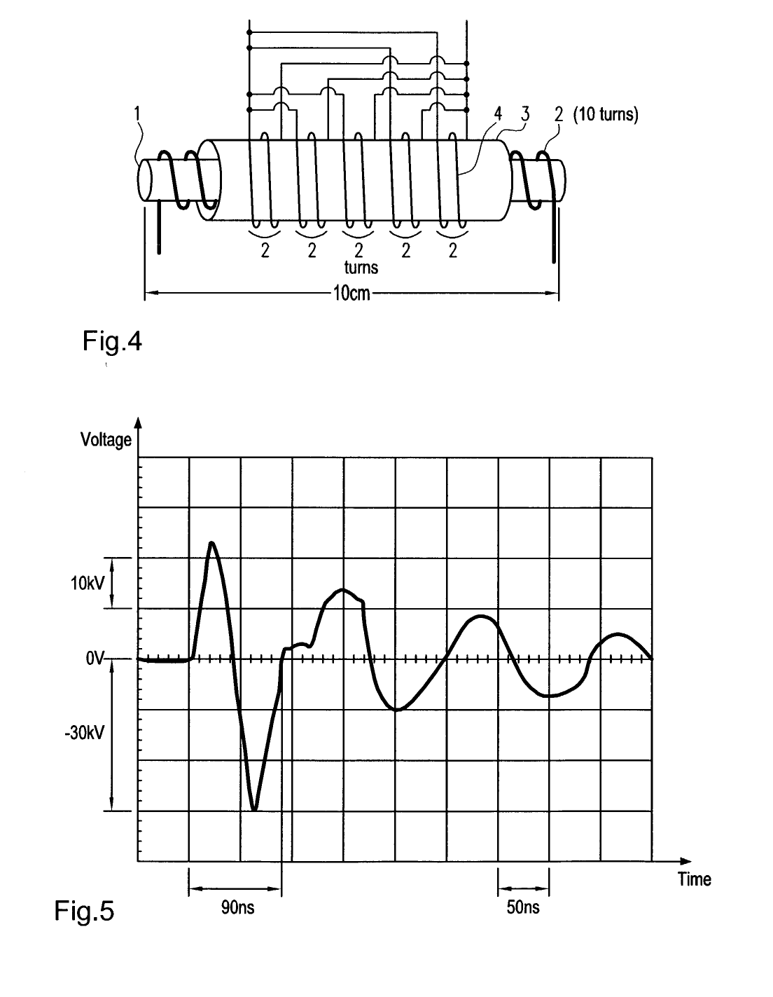

FIG. 4 shows the arrangement of a second embodiment of the pulse transformer 12a of the invention. The pulse transformer 12a in this embodiment is used in the starter circuit shown in FIG. 1(b), as in the first embodiment, and can be used for the lamp operating device shown FIG. 6.

In the pulse transformer 12a in the second embodiment of the invention, as shown in FIG. 4, the secondary winding 2 is wound onto the core 1. An insulating plate 3 is inserted thereon, and a primary winding 4 is wound over the insulating plate 3. As in the first embodiment, five primary windings 4 of the pulse transformer 12a are connected parallel to one another and are wound with two turns. The second embodiment is different from the first embodiment in that the respective turns are connected parallel to one another, wherein after the completion of the winding process of one winding, the next winding begins. In other words, five winding are connected in parallel to each other but each of the windings is completely wound around the core before the next winding begins.

This means that, in a winding of five windings of the primary side onto the core, the turn of a second winding begins at the point at which the turn of the first winding is completed. In the same way, at the sites at which the turns of the third and fourth windings were completed, the turns of the fourth and fifth windings are started. The respective turns are uniformly distributed on the core 1. The number of turns per unit length of the secondary winding 2 is 10, as in the first embodiment. The winding length L of the secondary winding 2 of the pulse transformer 12a is also roughly 10 cm.

FIG. 5 shows the output waveform from the starter circuit 12 in which the pulse transformer 12a is used according to the above described second embodiment. As described above, the difference from the first embodiment is only in the winding position of the respective windings of the primary side. The remaining arrangement is identical. The size of the pulse transformer is therefore identical to that in the first embodiment. As shown in FIG. 5, a voltage with a peak voltage of −30 kV and a period of roughly 90 ns is output. A peak voltage in the second embodiment higher than the peak voltage in the first embodiment is obtained. It can be understood that the reason for this is that the coupling of the primary side to the secondary side of the pulse transformer became higher than in the first embodiment by winding the primary windings in the manner described in the second embodiment.

Generally, using the present invention, a higher peak voltage can be obtained, and the lamp 13 can be subjected to insulation breakdown and operated properly even if the installation line, which extends from the starter circuit 12 to the lamp 13 as shown in FIG. 6, for example, has a long routing, or for similar reasons, causing the voltage supplied to the discharge lamp to drop slightly. This is regarded as an advantage of the present invention with respect to the installation line.

In the conventional case or in the case of the first embodiment the peak voltage is −24 kV. Hence, there is no margin for the above-mentioned insulation breakdown voltage of “greater than or equal to 23 kV to 24 kV” that is desirable for insulation breakdown of the lamp 13. Assuming that a voltage reduction of greater than or equal to 4 kV occurs, the voltage supplied to the lamp 13 is, therefore, less than or equal to −20 kV. In such case, the lamp does not operate.

On the other hand, in the second embodiment of the present invention, the peak voltage is −30 kV. As such, there is a margin for the desired insulation breakdown voltage of “greater than or equal to 23 kV to 24 kV”. Assuming that a voltage reduction of roughly 4 kV occurs, a voltage with a peak voltage of −26 kV can still be supplied to the lamp 13. Thus, the lamp 13 can be operated safely.

In the above described first and second embodiments, there are a plurality primary windings parallel to one another. Therefore, the coupling of the primary side and the secondary side of the pulse transformer is increased, and, as a result, the required voltage output is obtained, even if the winding number of the secondary side is reduced. In this way, the winding length L of the secondary winding can be shortened more than in the conventional case.

The pulse transformer can be made smaller and the length of the secondary winding is reduced by the arrangement of the pulse transformer according to the first embodiment or the second embodiment of the present invention. In this manner, the power loss due heat generation becomes smaller, and a smaller cooling fin can sufficient cool the pulse transformer. As a result the starter circuit is reduced in size to roughly 150 cm×200 cm×130 cm and to 40% of the volumetric ratio to a conventional starter circuit.

By reducing the size of the starter circuit, in the case of its arrangement within the light irradiation device, the arrangement of the lamp operating device was simplified. Furthermore, in the case of installation of the lamp operating device outside the light irradiation device, an increase in the size of the entire light irradiation device is obviated.

As was described above, the following effects can be obtained in accordance with the present invention:

(1) In a pulse transformer used for the starter circuit of the lamp operating device, a plurality primary windings are located parallel to one another, and the respective windings connected parallel to one another are wound around in the ways described below in (a) and (b). Therefore, the coupling of the primary windings to the secondary winding can be increased, and the peak voltage necessary for insulation breakdown of the discharge lamp can be obtained, even if the winding number of the secondary winding is reduced. As a result, it becomes possible to reduce the winding length of the secondary winding, even when the thickness of the secondary winding increases. In this way, the size of the pulse transformer can be decreased.

Furthermore, the number of winding of the secondary winding and the length of the secondary winding can be reduced. The power loss through heat generation is also reduced accordingly, and the cooling fin for air cooling of the pulse transformer can also be made smaller.

Using the present invention, the starter circuit which comprises the pulse transformer can be made smaller, as can the entire lamp operating device. Since the lamp operating device can be made smaller, an increase in the size of the light irradiation device inside or outside of which the lamp operating device is installed can also be avoided. The windings of the pulse transformer of the present invention are as follows:

(a) The respective windings are connected parallel to one another, wherein after completion of a winding around the core of the pulse transformer the next winding begins.

(b) The respective windings which are connected parallel to one another, are located next to one another on the core of the pulse transformer and are wound around the core.

(2) By winding the primary windings of the pulse transformer in the manner described above in (a), coupling of the primary side to the secondary side of the pulse transformer can be increased even more, and a higher peak voltage from the starter circuit can be produced. This makes it possible to effect the insulation breakdown between the electrodes of the discharge lamp even if the voltage is slightly reduced.

What I claim is:

1. A lamp operating device with a starter circuit, wherein a high voltage with a frequency component of at least 1 MHz is supplied to a discharge lamp producing an insulation breakdown between electrodes of a lamp and effecting luminous operation, the lamp operating device comprising:
a starter circuit having set-up circuit connected to a pulse transformer,
wherein the pulse transformer comprises a primary winding connected to the set-up circuit of the starter circuit, and a secondary winding for connection to a discharge lamp for supplying power to the discharge lamp,
wherein the primary winding of the pulse transformer is formed from a plurality of windings connected parallel to one another.

2. The device of claim 1, wherein the respective plurality of windings connected in parallel to one another are located on a core of the transformer and are wound around the core such that, after completion of a winding, a next winding begins.

3. The device of claim 1, wherein the respective plurality of windings connected parallel to one another are wound around a core of the pulse transformer and are located next to one another.
